(19) United States
(12) Patent Application Publication
(10) Pub. No.: US 2007/0247087 A1
(43) Pub. Date: Oct. 25, 2007

(54) Lamp power supply and protection circuit

(75) Inventors: James Lee, Monterey Park, CA (US); Kevin Chlebek, Wolverine Lake, MI (US)

Correspondence Address: HARNESS, DICKEY & PIERCE, P.L.C., P.O. BOX 828, BLOOMFIELD HILLS, MI, 48303, US

(73) Assignee: Marketing Displays Inc.

(21) Appl. No.: 11/409,477

(22) Filed: Apr. 21, 2006

(51) Int. Cl. H05B 37/02

(52) U.S. Cl. 315/291

(57) ABSTRACT

A power supply device for a CCFL or other lamp type regulates a current output to the CCFL regardless of lamp length and/or short circuit conditions. The power supply device for a lamp comprises a voltage regulating module that receives an input voltage signal and generates an output voltage signal that is substantially constant. A voltage driving module receives the output voltage signal and a detection signal, and generates a driving voltage signal. A current limiting module receives the driving voltage signal and generates a current supply signal that is substantially constant regardless of an impedance of a load that receives the current supply signal. A detection module communicates generates the detection signal. The detection signal is indicative of a voltage across the load. The voltage driving module discontinues the driving voltage signal if the detection signal indicates that the voltage is greater than a threshold.

### FIELD OF THE INVENTION

The present invention relates to a cold cathode fluorescent lamp (CCFL) circuit, and more particularly to current control of a CCFL circuit.

### BACKGROUND OF THE INVENTION

CCFL technology is being used more frequently for illumination in various types of display systems due to improved durability and efficiency over conventional methods. For example, CCFL technology is used for backlighting of LCD monitors or other computer displays. Additionally, CCFL technology is used in signs and instrumentation. Typically, an AC line voltage provides power for operating a CCFL device. A power supply or ballast is used to convert the AC line voltage to a voltage suitable for the CCFL device.

Variations in certain parameters of a CCFL system may adversely affect the operation of the power supply, the lamp, and/or other components. When the power supply provides power for more than one lamp, the performance of a first lamp may affect the performance of a second lamp. If the first lamp burns out or is otherwise damaged, the voltage and/or current of the second lamp may be affected. In other words, in typical CCFL systems, the impedance of each lamp affects the overall performance of the CCFL system. Factors that determine the impedance of a lamp include size (i.e. length), temperature, and other process variations.

Generally, a CCFL system provides a voltage based on particular lamp requirements. For example, the power supply provides a voltage for a particular lamp size. If the CCFL system is operated with an improper lamp (i.e. a lamp that is too large or too small), damage may occur to the lamp or other component of the CCFL system. Therefore, different power supplies must be used for different lamps. Additionally, if the CCFL system is operated with a missing or damaged lamp, damage may occur.

### SUMMARY OF THE INVENTION

A power supply device for a lamp comprises a voltage regulating module that receives an input voltage signal and generates an output voltage signal that is substantially constant. A voltage driving module receives the output voltage signal and a detection signal, and generates a driving voltage signal. A current limiting module receives the driving voltage signal and generates a current supply signal that is substantially constant regardless of an impedance of a load that receives the current supply signal. A detection module communicates with one of the current limiting module, the current supply signal, and/or the load, and generates the detection signal. The detection signal is indicative of a voltage across the load. The voltage driving module discontinues the driving voltage signal if the detection signal indicates that the voltage is greater than a threshold.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a CCFL circuit that implements current regulation and circuit protection according to the present invention;

FIG. 2 is a circuit schematic of a CCFL circuit that implements current regulation and circuit protection according to the present invention;

FIG. 3A is a waveform that illustrates output current for a first output of the CCFL circuit according to a first implementation of the present invention;

FIG. 3B is a waveform that illustrates output current for a second output of the CCFL circuit according to the first implementation of the present invention;

FIG. 4A is a waveform that illustrates output current for a first output of the CCFL circuit according to a second implementation of the present invention;

FIG. 4B is a waveform that illustrates output current for a first output of the CCFL circuit when a second output has a short circuit condition according to the second implementation of the present invention;

FIG. 4C is a waveform that illustrates output current for a second output of the CCFL circuit when the second output has a short circuit condition according to the second implementation of the present invention; and

FIG. 5 is a waveform that illustrates input current of the CCFL circuit according to the present invention.

### DETAILED DESCRIPTION OF THE PREFERRED EMBODIMENTS

The following description of the preferred embodiment(s) is merely exemplary in nature and is in no way intended to limit the invention, its application, or uses.

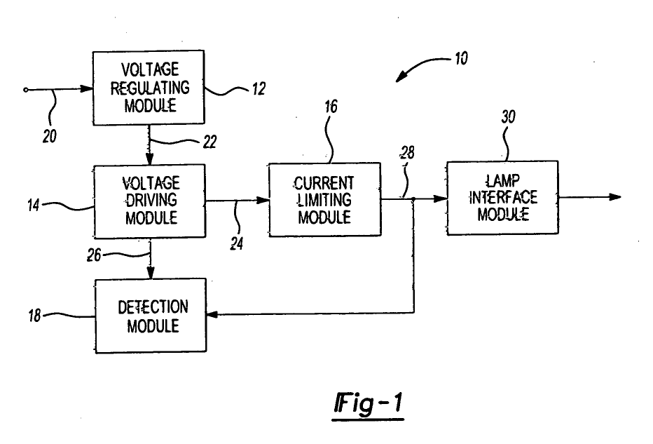

Referring now to FIG. 1, a CCFL circuit 10 includes a voltage regulating module 12, a voltage driving module 14, a current limiting module 16, and a detection module 18. The voltage regulating module 12 receives an input voltage signal 20 from a voltage source. For example, the voltage source may be any suitable AC voltage source ranging from approximately 90V-265V with a frequency ranging from 50 Hz to 400 Hz. The voltage regulating module 12 generates an output voltage signal 22. The output voltage signal 22 is substantially constant regardless of the value of the input voltage signal 20. In other words, the value of the output voltage signal 22 is substantially independent from the value of the input voltage signal 20. For example, in the preferred embodiment, the voltage regulating module 12 generates a constant output voltage signal 22 of 400V. However, those skilled in the art can appreciate that other suitable output voltage values may be used according to circuit performance requirements.

The voltage driving module 14 receives the output voltage signal 22 from the voltage regulating module 12. Additionally, the voltage driving module 14 is in communication with detection module 18. The voltage driving module 14 receives a detection signal 26 from the detection module 18. The voltage driving module 14 generates a driving voltage signal 24 according to the output voltage signal 22 and the detection signal 26. For example, the output voltage signal 22 determines an amplitude of the driving voltage signal 24. In one implementation, the voltage driving module 14 is a half-bridge driver as is known in the art. In this manner, the waveform of the driving voltage signal 24 is maintained at a specific polarity and frequency.

The current limiting module 16 receives the driving voltage signal 24 from the voltage driving module 14. The current limiting module 16 generates a current supply signal 28 according to the driving voltage signal 24. A lamp interface module 30 receives the current supply signal 28 from the current limiting module 16. In other words, the current limiting module 16 supplies current to power the lamp interface module 30 via the current supply signal 28. The current limiting module 16 maintains the current supply signal 28 at a constant value when the driving voltage 24 is a constant value. As described above, the voltage regulating module 12 and the voltage driving module 14 operate to ensure that the driving voltage signal 24 is a constant value. Therefore, the current supply signal 28 is a constant value regardless of the value of the input voltage signal 20. Further, the current supply signal 28 is constant regardless of load requirements of the lamp interface module 30. In the preferred embodiment, the current supply signal 28 is approximately 160 milliamps (mA). However, those skilled in the art can appreciate that other suitable current values may be used according to requirements of the lamp interface module 30.

The detection module 18 communicates with the current supply signal 28 and/or the lamp interface module 30 to determine an operating condition of the lamp interface module 30. For example, although the current supply signal 28 is constant, the load requirements (i.e. impedance) of one or more lamps of the lamp interface module 30 affect the voltage of the lamp interface module 30. Therefore, as an impedance of a lamp increases, the voltage across the lamp increases. The impedance of the lamp may be indicative of length or other characteristics of the lamp.

In this manner, the detection module 18 is able to determine if an improper lamp (i.e. a lamp of improper size) is being used with the lamp interface module 30 based on a voltage increase. Similarly, the detection module 18 is able to determine if a lamp is missing from the lamp interface module 30, resulting in an open circuit. In another possible condition, all lamps associated with the lamp interface module 30 may be present but damaged or burnt out, causing a voltage increase. Here again, the detection module 30 is able to detect such a condition. In the preferred embodiment, the detection module 18 senses a voltage increase due one of the above conditions and generates the detection signal 26 in response to the voltage increase. In other words, the detection signal 26 is indicative of one or more operating conditions of the lamp interface module 30. If the detection signal 26 indicates that the voltage increases above a threshold, the voltage driving module 14 shuts off the driving voltage signal 24 to prevent damage to the lamp interface module 30 or other elements of the CCFL circuit 10.

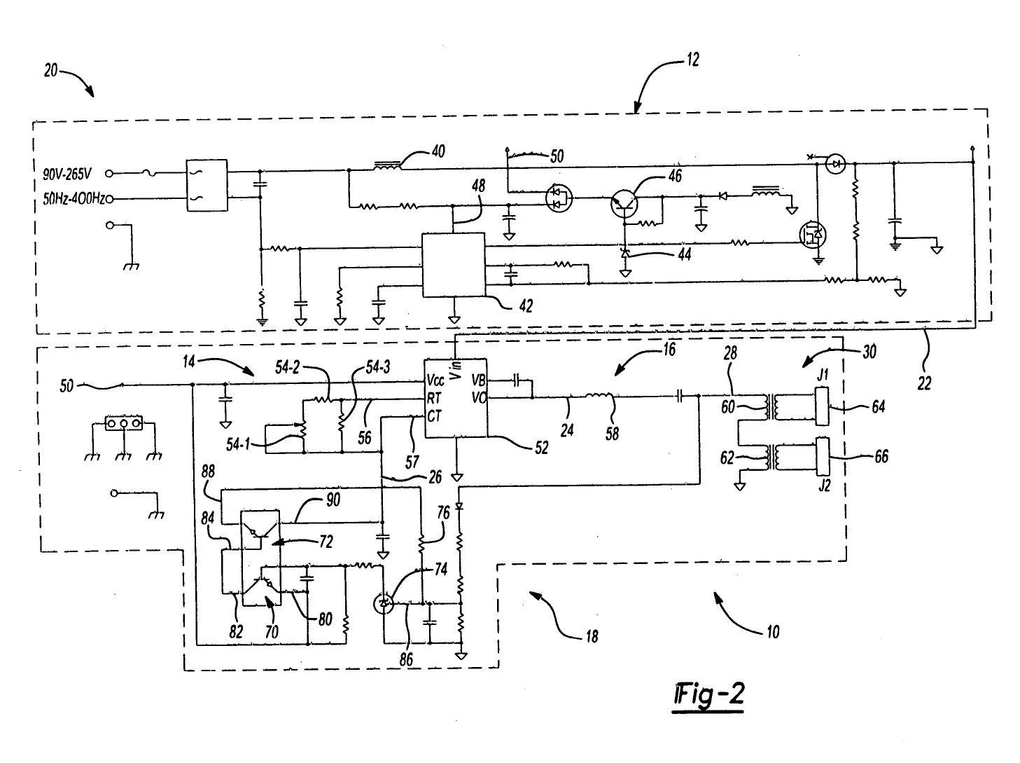

Referring now to FIG. 2, the voltage regulating module 12, the voltage driving module 14, the current limiting module 16, the detection module 18, and the lamp interface module 30 of one implementation of the CCFL circuit 10 are shown in detail. The voltage regulating module 12 receives the input voltage signal 20 and generates the constant output voltage signal 22 as described above. Generally, an inductor 40 regulates the output voltage signal 22. The voltage regulating module 12 also includes a power factor pre-regulator 42 and a VCC-regulating zener diode 44 and transistor 46. The voltage regulating module 12 therefore provides power factor correction for the input voltage signal 20. The zener diode 44 and the transistor 46 provide regulation for a VCC input 48 of the power factor pre-regulator 42 and for a VCC signal 50 supplied to other components of the CCFL circuit 10. For example, the voltage driving module 14 receives the VCC signal 50. Both the power factor pre-regulator 42 and the voltage driving module 14 require that the VCC signal 50 is within a particular range. Therefore, the zener diode 44 and the transistor 46 regulate the VCC signal 50 to ensure that the components that receive the VCC signal 50 operate properly.

The voltage driving module 14 includes a half-bridge driver 52 and timing resistors 54-1, 54-2, and 54-3, referred to collectively as timing resistors 54. The timing resistors 54 are connected across timing inputs 56 and 57 of the half-bridge driver 52 and determine a frequency of the driving voltage signal 24. The driving voltage signal 24 alternates between 400V and ground at the frequency determined by the timing resistors 54. In the present implementation, the frequency of the driving voltage signal 24 decreases as a resistance across the timing inputs 56 and 57 increases. Those skilled in the art can appreciate that any suitable combination of resistors can be used to determine a desired frequency.

The current limiting module 16 includes an inductor 58. The inductor 58 regulates the current supply signal 28. In the present implementation, the inductor 58 has an inductance of approximately 4.7 millihenries in order to regulate the current supply signal 28 at 160 mA according to the 400V output voltage signal 22.

The lamp interface module 30 includes transformers 60 and 62 and lamp sockets 64 and 66. The voltage and frequency of the driving voltage signal 24 supplied to the inductor 58 determines the current input to the transformers 60 and 62. More specifically, Iₚₚ=V/(4* L * F), where Iₚₚ is the peak-to-peak input current of the transformers 60 and 62 (i.e. the current supply signal 28), V is voltage of the driving voltage signal 24, L is the inductance of the inductor 58, and F is the frequency of the driving voltage signal 24.

The transformers 60 and 62 step down the current supply signal 28. In the present implementation, the current at the outputs of the lamp sockets 64 and 66 is approximately 8 mA. Although two transformers and corresponding lamp sockets are shown, it is to be understood that any suitable number of lamp sockets may be provided. In the present implementation, each transformer 60 and 62 is connected independently to the lamp sockets 64 and 66, respectively. In other words, each transformer 60 and 62 includes separate primary and secondary windings, rather than sharing a primary winding with the other transformer. The transformer 60 acts as a first current source for the lamp socket 64. Similarly, the transformer 62 acts as a second current source for the lamp socket 66. Since the primary windings of the transformers 60 and 62 are in series, the current through each transformer 60 and 62 is substantially identical. The output (i.e. secondary winding) of the transformers 60 and 62 are isolated, thereby isolating operating conditions of the lamp sockets 64 and 66 from one another. Changes in an impedance of a lamp connected to the lamp socket 64 do not affect the operation of the lamp socket 66. Analogously, changes in an impedance of a lamp connected to the lamp socket 66 do not affect the operation of the lamp socket 64. In this manner, the current supply signal 28 is able to power either of the lamp sockets 64 and 66 when the other is not functioning properly.

As described above with respect to FIG. 1, a voltage increase occurs when the lamps connected to both of the lamp sockets 64 and 66 are burnt out or otherwise not functioning properly, or when a lamp is missing. The detection module 18 detects the voltage increase. More specifically, the detection module 18 includes one or more voltage sensing devices. When a voltage at the voltage sensing device exceeds a particular threshold, the voltage driving module 14 shuts off the driving voltage signal 24 as described below in more detail.

The detection module 18 includes transistors 70 and 72, a comparator 74, and a latching resistor 76. During normal operating conditions, the transistor 70 is OFF, and no current flows between nodes 80 and 82 of the transistor 70. As such, the transistor 70 does not provide current to node 84 of the transistor 72, and there is no electrical communication between the transistor 72 and the timing input 57. When the voltage at node 86 exceeds the threshold, the transistor 70 is ON. In the present implementation, the threshold is 2.5V. The VCC signal 50 (13.5 V in the present implementation) is applied through the transistor 70 to node 84, through the transistor 72, and to the timing input 57. The timing input 57 of the voltage driving module 14 also functions as a shutoff input. When the voltage at the timing input 57 exceeds a threshold, the voltage driving module 14 interrupts the driving voltage signal 24.

Those skilled in the art can appreciate that certain components of the CCFL circuit 10, and in particular the detection module 18, may be replaced with electrical components having analogous functions without departing from the features of the invention. For example, the transistor 72 may be replaced with a first diode and a second diode that are connected between nodes 84, 88, and 90. The anodes of the first and second diode are connected together at node 84.

In a further feature of the invention, current flows through the transistor 72 between nodes 84 and 88 when the transistor 70 is on. The VCC signal 50 is applied to the comparator 74 through the latching resistor 76. In other words, the transistors 70 and 72 and the latching resistor 76 provide a positive voltage via the VCC signal 50 to the comparator 74. In this manner, the detection module 18 maintains the voltage at the timing input 57 at a level such that the voltage driving module 14 is OFF. To resume normal operation, the input voltage signal 20 of the CCFL circuit 10 must be reset or cycled.

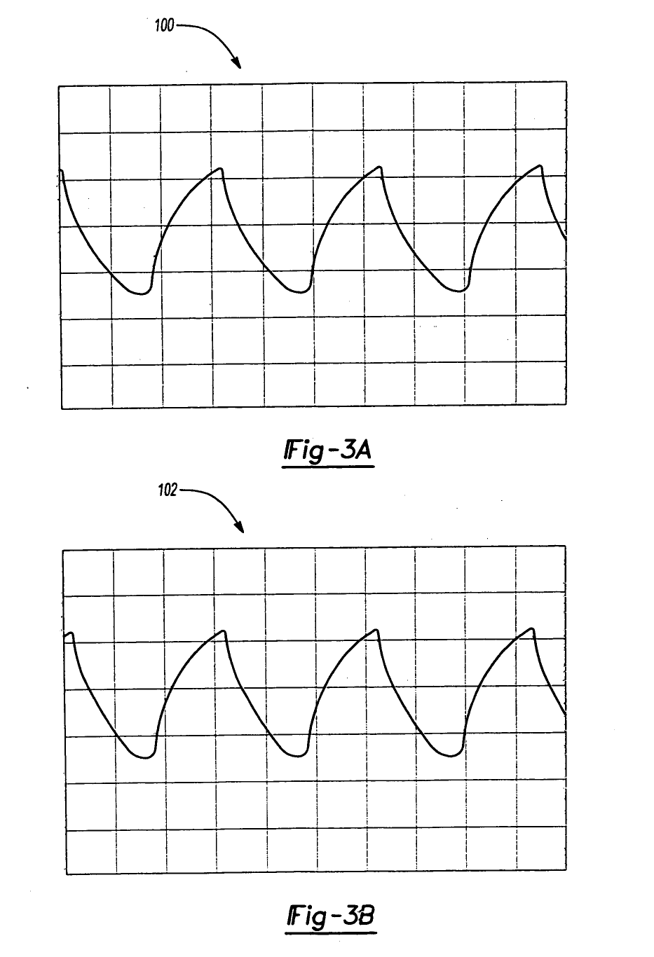

Referring now to FIG. 3A, an output current waveform 100 of the of the CCFL circuit 10 is shown. The output current waveform 100 demonstrates the output current at the lamp socket 64 when a first lamp connected to the lamp socket 64 is 24 inches long and a second lamp connected to the lamp socket 66 is 14 inches long. Referring now to FIG. 3B, an output current waveform 102 demonstrates the output current at the lamp socket 66 with the same configuration as described in FIG. 3A. As shown in FIGS. 3A and 3B, the output currents at the lamp sockets 64 and 66 are substantially identical regardless of lamp length. For both waveforms 100 and 102, a 115 VAC, 60 Hz input voltage signal 20 was used.

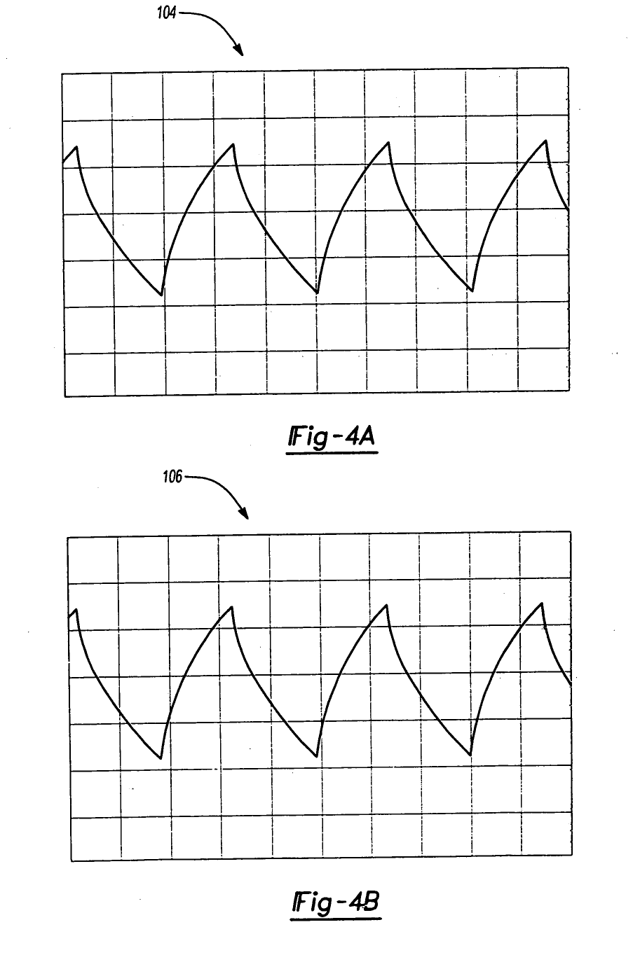

Referring now to FIG. 4A, an output current waveform 104 of the CCFL circuit 10 is shown. The output current waveform 104 demonstrates the output current at the lamp socket 64 when a first lamp connected to the lamp socket 64 and a second lamp connected to the lamp socket 66 are both 24 inches long. Referring now to FIG. 4B, an output current waveform 106 demonstrates the output current at the lamp socket 64 when a first lamp connected to the lamp socket 64 is 24 inches long and the second lamp socket 66 is short circuited. Referring now to FIG. 4C, an output current waveform 108 demonstrates the output current at the lamp socket 66 when a first lamp connected to the lamp socket 64 is 24 inches long and the second lamp socket 66 is short circuited. As shown in FIGS. 4A, 4B, and 4C, the output currents at the lamp sockets 64 and 66 are substantially identical regardless of lamp length. Further, a short circuit condition at either lamp socket 64 or 66 does not affect the output current. For all waveforms 104, 106, and 108, a 115 VAC, 60 Hz input voltage signal 20 was used.

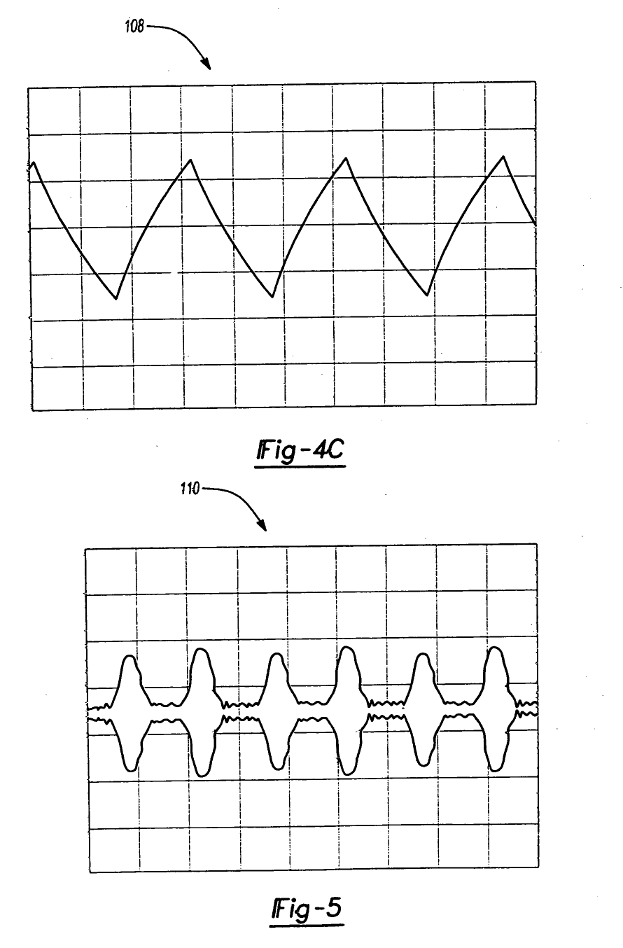

Referring now to FIG. 5, an input current waveform 110 of the CCFL circuit 10 is shown. The input current waveform 110 demonstrates the input current at the input voltage signal 20 when a first lamp connected to the lamp socket 64 is 24 inches long and a second lamp connected to the lamp socket 66 is 14 inches long. In this manner, it can be seen that the input current is a continuous 60 Hz sine wave regardless of lamp length as a result of the power factor correction features of the invention. For the input current waveform 110, a 115 VAC, 60 Hz input voltage signal 20 was used. Those skilled in the art can appreciate that the configurations demonstrated in FIGS. 3-5 are merely exemplary, and that the present invention can be extended to any number of configurations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A power supply device for a lamp comprising:
a voltage regulating module that receives an input voltage signal and generates an output voltage signal that is substantially constant;
a voltage driving module that receives the output voltage signal and a detection signal, and that generates a driving voltage signal;
a current limiting module that receives the driving voltage signal and generates a current supply signal that is substantially constant regardless of an impedance of a load that receives the current supply signal; and
a detection module that communicates with one of the current limiting module, the current supply signal, and/or the load, and that generates the detection signal,
wherein the detection signal is indicative of a voltage across the load and the voltage driving module discontinues the driving voltage signal if the detection signal indicates that the voltage is greater than a threshold.

2. The power supply device of claim 1 wherein the input voltage signal is an AC voltage signal.

3. The power supply device of claim 1 wherein the output voltage signal is a DC voltage signal.

4. The power supply device of claim 1 wherein the voltage regulating module includes a power factor correction module.

5. The power supply device of claim 4 further comprising an operating voltage regulator circuit that receives the input voltage signal and generates a constant operating voltage signal, wherein at least one of the power factor correction module and/or the voltage driving module receives the operating voltage signal.

6. The power supply device of claim 5 wherein the voltage regulating module includes the operating voltage regulator circuit.

7. The power supply device of claim 1 wherein the driving voltage signal has a constant polarity.

8. The power supply device of claim 7 wherein the voltage driving module includes a half-bridge driver circuit.

9. The power supply device of claim 1 wherein the current limiting module includes at least one inductor.

10. The power supply device of claim 1 further comprising a lamp interface module that receives the current supply signal.

11. The power supply device of claim 10 wherein the lamp interface module includes a first transformer having a first primary winding and a first secondary winding, and a second transformer having a second primary winding and a second secondary winding.

12. The power supply device of claim 11 wherein the first transformer communicates with a first load and the second transformer communicates with a second load.

13. The power supply device of claim 12 wherein the first load and the second load are cold cathode fluorescent lamps (CCFLs).

14. The power supply device of claim 12 wherein the voltage across the load is indicative of an impedance of one of the first load and/or the second load.

15. The power supply device of claim 11 wherein the current supply signal maintains a constant current through the first primary winding and the second primary winding.

16. The power supply device of claim 1 wherein the detection module further comprises:
a voltage comparator that senses the voltage across the load, determines whether the voltage across the load is greater than the threshold, and generates a switch control signal that is indicative of the voltage across the load; and
a switch that receives the switch control signal, that is closed when the switch control signal indicates that the voltage across the load is greater than the threshold, and that is open when the switch control signal indicates that the voltage across the load is below the threshold,
wherein the detection module generates the detection signal when the switch is closed.

17. The power supply device of claim 1 wherein the voltage comparator continuously maintains the switch control signal at a level that indicates that the voltage across the load is greater than the threshold.

18. A CCFL power supply circuit comprising:
a voltage regulating module that receives an input voltage signal and generates an output voltage signal that is substantially constant;
a voltage driving module that receives the output voltage signal and a detection signal, and that generates a driving voltage signal;
a current limiting module that receives the driving voltage signal and generates a current supply signal;
a first transformer having a first primary winding that receives the current supply signal and generates a first output current to a first CCFL device;
a second transformer having a second primary winding that receives the current supply signal and generates a second output current to a second CCFL device; and
a detection module that senses a detection voltage that is indicative of a voltage across one of the first CCFL device and/or the second CCFL device and generates the detection signal,
wherein the current limiting module maintains the current supply signal at a constant level regardless of an impedance of the first CCFL device and/or the second CCFL device, the detection signal is indicative of the detection voltage, and the voltage driving module discontinues the driving voltage signal if the detection signal indicates that the detection voltage is greater than a threshold.
